(19) United States
(12) Patent Application Publication
(10) Pub. No.: US 2007/0023572 A1
(43) Pub. Date: Feb. 1, 2007

(54) Fuselage

(75) Inventors: Rainer Muller, Rosengarten (DE); Peter Turanski, Sustedt (DE); Wilko Oestereich, Bremen (DE); Reinelt Thorsten, Stuhr (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: AIRBUS DEUTSCHLAND GMBH, Hamburg (DE)

(21) Appl. No.: 10/596,979

(22) PCT Filed: Jan. 5, 2005
(86) PCT No.: PCT/EP05/00038

§ 371 Date: Sep. 26, 2006

Related U.S. Application Data
(60) Provisional application No. 60/600,105, filed on Aug. 9, 2004.

(30) Foreign Application Priority Data
Jan. 5, 2004 (DE) 10 2004 001 078.1

(51) Int. Cl. B64C 1/10

(52) U.S. Cl. 244/121

(57) ABSTRACT

The fuselage according to an exemplary embodiment is conceived in such a way as to prevent the spread of flames produced by a source of fire and acting on the fuselage from outside the aircraft environment. The fuselage concept takes into account materials or material combinations that will scarcely allow protection of the cabin area of an aircraft (upon emergency landing) to be violated by flames spreading from outside the aircraft environment, which may facilitate an evacuation of passengers from the aircraft. An aircraft fuselage, whose fuselage structure, in addition to other structural elements that are components of the mechanical strength bracing of the fuselage and help absorb its forces, encompasses an exterior skin consisting of various respective materials, which are designed to be resistant to shear, and incorporated as a bearing element into the mechanical strength bracing to absorb and transfer the forces and torques acting thereupon. The exterior skin is fabricated from a burn-through resistant semi-finished material consisting of a non-metallic material or a fireproof metallic material, wherein the semi-finished material can be molded through further processing. Also, the exterior skin may be realized by a semi-finished material combining a non-metallic material and a metallic material, wherein the produced exterior skin product is a hybrid material that can be molded and joined through further processing.

### CROSS REFERENCE TO RELATED APPLICATIONS

The present application claims priority of DE 10 2004 001 078 filed Jan. 05, 2004 and U.S. Ser. No. 60/600,105 filed Aug. 09, 2004, which are both hereby incorporated by reference.

### FIELD OF THE INVENTION

The invention relates to a fuselage in particular of a commercial aircraft.

### BACKGROUND OF THE INVENTION

In the past, aluminium structures were highly successful in aircraft construction. Without going any further into detail on this matter, any expert, and most likely even a layman enthusiast interested in aircraft construction, knows that the traditional structural design of a fuselage involves an outer fuselage skin made solely of aluminium or aluminium alloys. Prior art provides the relevant examples for this.

There are accidents that were regrettably traced back to fires caused by kerosene leaking from an aircraft that had performed an emergency landing. Due to this, there may be a need for an aircraft having an improved fire protection.

In the event of a fire started during an emergency belly landing of an aircraft, (ignited) burning kerosene leaking from the aircraft may cause both the aluminium airframe of the aircraft structure and the interior insulation to burn through or away.

Publication “WO 00/75012 A1” now discloses a solution with which any outbreak of fire can be countered in the emergency situation described. This solution relates to fuselage insulation for one aircraft fuselage referred to as “fire-resistant”. This publication discloses an insulating package lying inside an expanse between the interior fuselage cladding and exterior fuselage skin as a primary insulation. Areas of this insulation package are here protected by a film consisting of fire-resistant material (“fire blocking material”), wherein this fire-resistant film area directly faces the exterior skin of the aircraft fuselage (like a fire protection shield). In addition to the fact that this proposal can only provide inadequate protection of the insulation package and the interior fuselage area against fires, since given a catastrophic fire, the flames from the fire that pass precisely from outside the aircraft through a damaged exterior skin and approach the interior insulation a short time later, i.e., also pass through the (only) fire-resistant, but not fireproof film given prolonged exposure to fire, the intended area-by-area arrangement of a merely fire-resistant film would be unable to ensure a sufficient level of fire safety relative to the interior fuselage area. The publication also proposes corresponding attachment elements for securing the fuselage insulation, which most often consist of plastic(s), e.g., a polyamide.

The publication makes no mention of additional measures available for preventative fire protection, which are geared toward the technical design of the aircraft fuselage in terms of fire safety, and additionally aimed at the external fuselage skin.

### SUMMARY OF THE INVENTION

According to an exemplary embodiment of the present invention, an aircraft fuselage may be provided, comprising an exterior skin product. The external skin product is made of a semi-finished material. The semi-finished material is a combination of a non-metallic material and a metallic material. The exterior skin product is a hybrid material that is moldable and joinable through further processing.

According to another exemplary embodiment of the present invention, an aircraft fuselage may be provided, comprising an exterior skin which is fabricated from a burn-through resistant semi-finished material made of a non-metallic material or a fireproof metallic material, wherein the semi-finished material can be molded through further processing.

The fuselage according to an exemplary embodiment of the present invention may be is conceived in such a way as to prevent the spread of flames produced by a source of fire and acting on the fuselage from outside the aircraft environment. The fuselage concept takes into account materials or material combinations that will scarcely allow protection of the cabin area of an aircraft (upon emergency landing) to be violated by flames spreading from outside the aircraft environment, which is believed to tangibly facilitate an evacuation of passengers from the aircraft. Furthermore, it is believed that the fire safety of an outside or external fuselage skin of an aircraft fuselage may be improved in such a way as to achieve a high burn-through behavior of the skin.

### BRIEF DESCRIPTION OF THE DRAWINGS

The invention is described in greater detail with reference to an exemplary embodiment with reference to the following drawings.

FIG. 1 shows an aircraft fuselage of a passenger aircraft depicting elements of the fuselage structure and interior equipment according to an exemplary embodiment of the present invention;

FIG. 2 shows a selected area of the external skin and other structural elements of the fuselage structure according to an exemplary embodiment of the present invention.

### DETAILED DESCRIPTION OF EXEMPLARY EMBODIMENTS

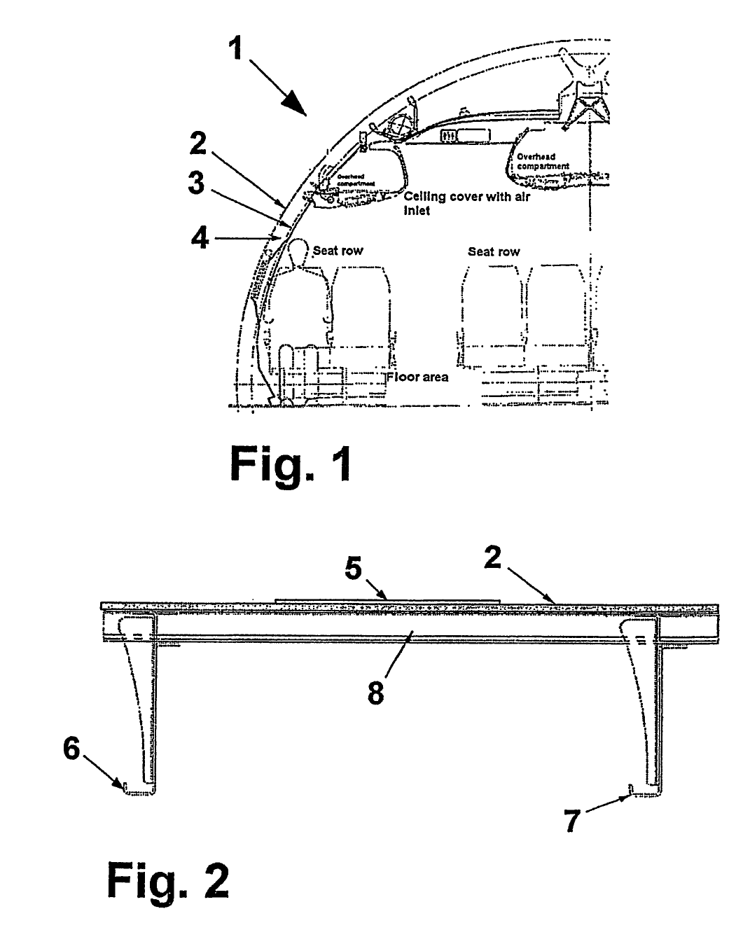

FIG. 1 shows an excerpt of a cross section of the fuselage from a passenger plane, restricted to a sectional area of an aircraft passenger cabin 1. This arrangement would likely be familiar an expert in aircraft construction, and discloses relations from which the observer may recognize that a combustible interior cladding 3 is situated very close (in terms of the fuselage) to the external skin 2, which when installed together with the exterior skin 33 encompasses a space 19 within which the fuselage insulation (not shown on FIG. 1) is installed. If an exterior skin 2 traditionally realized with an aluminum material or aluminum alloy is installed in this configuration, the observer will be able to weigh the extent of a catastrophic fire of the kind described at the outset. The additional parts and elements of the interior equipment and fuselage structure shown on FIG. 1 and integrated into an aircraft passenger cabin 21 (based on the example therein) will not be described, since they are considered to be irrelevant with respect to the present invention.

FIG. 2 shows a skin field section of the exterior skin 2 that is affixed to the stringer 8. The skin field is restricted to the area of skin bordered by two ribs 6, 7 secured to the stringer, which are aligned perpendicular to the fuselage longitudinal axis. For the sake of completeness, let it be mentioned that the exterior skin 2, the stringer(s) 8 and the ribs 6, 7 are constituents of the mechanical strength bracing of the fuselage, and participate in its absorption of forces, wherein the exterior skin 2 consists of different respective materials, generally of the mentioned material “aluminum or aluminum alloy”, which are designed to be resistant to shear. The exterior skin 2 is incorporated into the mechanical strength bracing as a bearing element to absorb and transfer the forces and torques acting thereupon.

It is believed that the proposed solution follows the concept of a prophylactic or preventative fire safety for an aircraft, so that an induced high burn-through behavior of the exterior skin 2 may increase the technical fire safety of a passenger or military aircraft, first and foremost of a passenger plane, so that it is believed that a fire situation of the kind described at the outset cannot develop into a catastrophe, e.g., after an aircraft has made a successful emergency landing.

The proposed solution is based A) on the use of a material for exterior skin 2, which is provided with a fireproof (plate-like) semi-finished material consisting of a non-metallic material or a fireproof metallic material, wherein the semi-finished material can be molded through further processing to convert the inwardly curved contour of the fuselage skin 2.

On the other hand, B) proposes that the exterior skin 2 be realized by combining a semi-finished material comprised of a non-metallic material and a metal material. The produced exterior skin product of such a material combination is a hybrid material, which can be molded and joined through further processing. This material combination is achieved by means of a non-metallic material consisting of carbon and glass fibers (in mixed-fiber architecture) or only carbon and glass fibers and/or ceramic fibers, and a metal material, wherein the metal material consists of an aluminum or a titanium or an aluminum or titanium alloy.

The desired arrangement is coated by a resin layer or imbedded in a resin. The obtained exterior skin product with this material combination has a sandwich design. This sandwich design is adhesively bonded with a composite material and the mentioned metal material in layers (films), which yields a burn-through resistant behavior of the exterior skin relative to long-term exposure to flames from a fire. In addition, the sandwich design can be realized using a glare material, whose burn-through behavior is high.

Returning to these steps A) and B), we expand the scope by manufacturing the exterior skin 2 [or processing the semi-finished material] using a non-metallic material consisting of a carbon fiber material or a glass fiber material or a ceramic fiber material or a silicate fiber material. One would also have to remember that a material combination comprised of the various non-metallic materials is taken into account when manufacturing the exterior skin (2) according to B). In this case, it is provided that the non-metallic material be realized with plastics reinforced with glass or plastic fibers (a GFK and/or CFK material). The mentioned material combination can here be realized with a GFK or CFK material and aluminum or titanium or alloys thereof.

The mentioned composite material involves a heatproof composite material, whose behavior also exhibits a temperature resistance and tensile strength. It is proposed that this heatproof material be realized with carbon fibers, coated with material from a nitride or carbide bond, e.g., silicon carbide, silicon nitride or boron nitride, and a metal or ceramic material, into which the coated carbon fibers are imbedded.

Further, the fireproof, metallic material mentioned relative to A) is realized with titanium or a titanium alloy.

In order to complement the concept of preventative fire safety (examined here) for an aircraft, C) additionally proposes that the outer surface of the (burn-through resistant) exterior skin 2, namely the area of skin exposed to weathering from the outside environment of an aircraft, be joined with a plate-like planking 5 based on the example on FIG. 2. This planking 5 is also to be realized with the burn-through resistant semi-finished product using a non-metallic material or a fireproof metallic material. On the other hand, it is possible to realize the planking 5 according to B) with the mentioned material combination of the semi-finished product using a non-metallic material and a metal material, whose produced exterior skin product is a hybrid material, wherein the planking can also be molded and joined through further processing. The planking 5 will exhibit a fire-safe(r) behavior, and can also be molded to reflect the outer contour of the exterior skin 2. It may be realized with a GLARE material. Otherwise, the preventative fire safety could already be implemented by joining the exterior skin 2 with planking 5 tailored to its outer contour, with the entire outer surface of the exterior skin 2 being coated, of course. Given this assumption, the exterior skin 2 can even be realized with a material comprised of an aluminum or aluminum alloy, joined precisely to the bum-through resistant, plate-like planking.

It is believed that an aircraft fuselage made burn-through resistant is used to achieve the highest level of safety for a passenger plane relative to fire exposure from outside. A bum-through resistant aircraft fuselage may afford optimal protection against fire entering the cabin, since it is the furthest removed from the passenger seat installed within the fuselage, and prevents flames from penetrating at their source. If the aircraft fuselage is now manufactured out of burn-through resistant materials, e.g., as possible with carbon fiber structures, it may also become unnecessary to assemble burn-through resistant attachment elements for mounting an additional “fire barrier” (not discussed in any greater detail here), which is enveloped by a fuselage insulation situated in the space 4 and completely encapsulated by a burn-through resistant film made of a fireproof film material. The so-called fire barrier should function should be defined as a minimal requirement for the fuselage structure, since this requires no weight-increasing, additional components to ensure burn-through safety, although the latter will likely not be as high as would be the case with the introduced aircraft fuselage.

Advanced, truly reliably burn-through resistant aircraft can also be realized by having the exterior skin 2, which most often normally consists of an approx. 1.5 to 3 mm thick aluminum sheet, be replaced with burn-through resistant sheets of the kind introduced.

Burn-through resistant exterior skin sheets can be realized using the following materials, for example:
a) Carbon fiber materials (CFK) consisting of aramide,
b) Glass fiber materials (GFK),
c) Fireproof metals like titanium,
d) Ceramic fiber materials, and
e) Silicate fiber materials.

The advantage to these materials is that they exhibit a clearly higher melting point than is the case for aluminum.

As a result, these materials are distinctly more resistant in cases of fire.

The different materials can be combined with each other to achieve optimal properties with respect to processing, strength, weight and bum-through behavior. Reference is then made to so-called “composite materials” or “sandwich structures”. In this case, the different materials are adhesively bonded or glued to each other. A behavior in fires may be further optimized or improved by using especially temperature-resistant adhesives here.

The burn-through resistant sheets fabricated in this manner can then be riveted with the ribs 6, 7 and stringer 8, just as conventional aluminum exterior skin sheets of the aircraft.

The reinforcing elements, called the stringer 8 and ribs 6, 7, responsible for the special structural integrity of the aircraft fuselage can also be made out of conventional materials (aluminum), since they are already inwardly situated relative to the exterior skin 2 of the aircraft, and protected by the burn-through resistant planking 5 against flames from a so-called “post-crash fire”. Even so, it is possible to manufacture all other components, such as the stringer 8, ribs 6, 7 and clips, out of the same burn-through resistant material.

The following advantages to the proposed solution are believed to be achieved. In comparison to all other arrangements of a fire barrier for a passenger plane, the use of a burn-through resistant aircraft fuselage is particularly effective. No additional components are believed to be necessary, which is especially cost-effective and weight-neutral. In this case, the passenger may be protected against the propagation of flames into the cabin in comparison to all other similar solutions. Since the actual fuselage structure of the aircraft is protected against burn-through, components traditionally mounted to the aircraft airframe, e.g., the interior cladding 3 and fuselage insulation, are prevented from falling on the passengers, endangering them or impeding the evacuation.

Reference List

1 Aircraft passenger cabin
2 Exterior skin (of aircraft fuselage)
3 Interior cladding
4 Space
5 Planking
6, 7 Rib
8 Stringer

1-16. (canceled)

17. An aircraft fuselage, having a fuselage structure, comprising:
an exterior skin which is designed to be part of the structural elements that are components of the mechanical strength bracing of the fuselage and help absorb its forces and is made of materials designed to be resistant to shear, and incorporated as a bearing element into the mechanical strength bracing to absorb and transfer the forces and torques acting thereupon, wherein the exterior skin is realized by a semi-finished material combining a non-metallic material and a metallic material, such that the exterior skin is a hybrid material capable of being molded and joined by further processing, wherein the exterior skin comprises a non-metallic material having fibers selected from the group of fibers consisting of carbon fibers, glass fibers, ceramic fibers, and combinations thereof and a metal material selected from the group of metal materials consisting of an aluminum, a titanium, an aluminum alloy, a titanium alloy, and combinations thereof, wherein the nonmetallic material and the metal material are coated by a resin layer or imbedded in a resin.

18. The aircraft fuselage of claim 17, wherein the exterior skin includes a sandwich design, adhesively bonding a composite material and the metal material in layers, such that the sandwich design yields a burn-through resistant exterior skin during exposure to flames from a fire.

19. The aircraft fuselage of claim 18, wherein the composite material is a non-metallic material having fibers selected from the group of fibers consisting of carbon fibers, glass fibers, ceramic fibers, silicate fibers and combinations thereof.

20. The aircraft fuselage of claim 19, wherein a material combination comprised of the various non-metallic materials is taken into account when manufacturing the exterior skin.

21. The aircraft fuselage of claim 17, wherein the non-metallic material includes plastics reinforced with glass or plastic fibers.

22. The aircraft fuselage of claim 17, wherein the metal material is made of titanium or of a titanium alloy.

23. The aircraft fuselage of claim 18, wherein the composite material is of a GFK or CFK material and the metal material is of an aluminum, an aluminum alloy, a titanium, a titanium alloy, or combinations thereof.

24. The aircraft fuselage of claim 18, wherein the composite material is a heatproof composite material, exhibiting a temperature resistance and tensile strength when exposed to high temperatures during a.

25. The aircraft fuselage of claim 24, wherein the heatproof composite material includes carbon fibers coated with material from a nitride or carbide bond, and a metal or ceramic material, into which the coated carbon fibers are imbedded.

26. The aircraft fuselage of claim 18, wherein the sandwich design is realized using a glare material, having a high burn-through behavior.

27. The aircraft fuselage of claim 17, wherein an outer surface of the exterior skin exposed to weathering is joined with a plate-like planking the planking being comprised of a non-metallic material, a fireproof metallic material, or a combination material, the combination material being comprised of a non-metallic material and a metal material, such that the planking is capable of being molded and joined by further processing.

28. The aircraft fuselage of claim 27, wherein the planking is formed such that the planking is protective against burn through and adjusted to an outer contour of the exterior skin.

29. The aircraft fuselage of claim 28, wherein the planking is realized using a glare material.

30. The aircraft fuselage of claim 29, wherein the exterior skin comprises(2) an aluminum or an aluminum alloy joined to the planking.
